(19) United States
(12) Patent Application Publication
(10) Pub. No.: US 2006/0077905 A1
(43) Pub. Date: Apr. 13, 2006

(54) Measure and recording of traffic parameters in data transmission networks

(75) Inventors: Raymond Philip Russell, Dublin (IE); Ian Edward Dowse, Dublin (IE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Corvil Limited

(21) Appl. No.: 11/285,989

(22) Filed: Nov. 23, 2005

Related U.S. Application Data
(63) Continuation-in-part of application No. 10/875,179, filed on Jun. 25, 2004.
Application No. 10/875,179 is a division of application No. 09/608,108, filed on Jun. 30, 2000, now Pat. No. 6,771,607.

(51) Int. Cl. H04J 1/16; H04L 12/26

(52) U.S. Cl. 370/252

(57) ABSTRACT

A method and apparatus for measuring and recording traffic at nodes in a data transmission network is described. In particular, a method of accurately counting individual activities of traffic at individual nodes. The invention uses a counter or number of counters which count individual activities of traffic on a preset activity condition being sensed at a node. The data output from the counter is then fed to a buffer so as to provide an historical overview of the traffic may be provided. The invention has the advantage that accurate measurement of traffic at a node is achieved.

### CROSS-REFERENCES TO RELATED APPLICATIONS

This application is a continuation-in-part of prior U.S. application Ser. No. 10/875,179, filed Jun. 25, 2004, entitled MEASURE AND RECORDING OF TRAFFIC PARAMETERS IN DATA TRANSMISSION NETWORKS which is a division of prior U.S. application Ser. No. 09/608,108, filed Jun. 30, 2000, also entitled MEASURE AND RECORDING OF TRAFFIC PARAMETERS IN DATA TRANSMISSION NETWORKS.

### TECHNICAL FIELD

Embodiments of the present invention relate to a method and apparatus of measuring and recording various parameters of traffic at nodes in a data transmission network; in particular, to the provision and use of a sampling circuit for the measurement and recording of such traffic parameters.

### BACKGROUND

Any data transmission network comprises switches or routers in which traffic is carried in flows defined by identifiers, which may be VC/VP pairs in an ATM switch, source or destination address pairs in an IP router or a logical prefix-based aggregations of source or destination addresses. Traffic management schemes are based on measurement of traffic load and for such schemes to work effectively, the measurement must be accurate. The most fundamental form of measurement is a sample of the bit-rate of the traffic and the timescale over which such a measurement is made determines how much information can be deduced from it. If the timescale is relatively long such as the order of hours or days, then all that can be deduced is the average traffic load and the measurement tells nothing whatsoever of the typical delays or indeed packet-drop rates. In order to deduce the latter, sampling of the traffic rate must take place using a timescale at which packet queuing occurs, namely, that of the order of tens of milliseconds. Making accurate rate-measurements in such timescales is extremely challenging and difficult. Current networking hardware can count various quantities relating to traffic streams, such as the number of arriving packets and arriving bytes. In order to make bit-rate measurements, software within the switch or router operating system must poll the byte counter, read the system time, set the software timeout and then read the byte counter and system time again. The bit-rate sample is then calculated as the ratio of:

$$\frac{( Final byte \text{-} count ) - ( initial byte \text{-} count )}{( Final time ) - ( initial time )}$$

Unfortunately, there are traditionally a number of serious problems with a solely software-based system when used to measure and record traffic parameters.

First, arranging for times of software timers to expire accurately can be difficult, especially at a timescale of 10 ms. Even if such software timers are accurate, the underlying architecture does not scale well. If the counting process is handling many counts at once, the counting process needs to use its timer many times, namely, once for each count. When the counter periods overlap, the actual timeout periods may be much shorter than the timescale of the count, namely, 10 ms, mentioned already, for any individual count. Thus, in practice, many counts will interfere with each other in software, leading inevitably to reduce accuracy for all the counts.

A further problem is that even if the number of counts and/or counter is such that they can be handled correctly, it is virtually impossible to guarantee that the times in which the byte counters are read will be recorded and/or clocked accurately. Effectively, software processes are programmed to poll the byte counter and then immediately read the system clock. However, there is no guarantee that the actual process will not be preempted by another process having a higher priority or by a hardware interrupt between polling the counter and reading the clock. Obviously, if the counting process is preempted, it makes the current count unusable and/or inaccurate. A further problem is that typically there will be no record of this interrupt and thus the process cannot discard that particular faulty count and reject it but it will be used for further processing.

Finally, a major drawback inherent in using software alone is that even if the counting and timing could be carried out accurately, there is a limitation in that, in effect, rate samples can only be taken over specified periods of time. In some applications, it is important to be able to time a specific feature and/or function, such as how long it takes for a fixed number of bytes to arrive. Unfortunately, the latter timing is impossible to achieve in software without a busy loop constantly polling the bye counter, which would effectively leave the CPU unusable for any other purpose. Accordingly, carrying out such a task by way of software alone is relatively useless for traffic management.

### SUMMARY

At least one embodiment of the present invention is directed towards providing a method and apparatus for rate sampling by measuring and recording various parameters of traffic of at least some of the nodes in a data transmission network.

In accordance with at least one embodiment of the invention, there is provided a method of measuring and recording various parameters of traffic at least at some of the nodes in a data transmission network in a rate sampling piece of hardware. Exemplary nodes include network switch routers, destination addresses, and so on. At least some of the nodes in the data transmission network are connected to at least one system counter provided in software.

In accordance with another feature of at least one embodiment, the method comprises enabling a group of counters; counting various individual activities of the traffic at the node as separate system activity counts; and providing a simultaneous real time count.

In accordance with a further feature of at least one embodiment, the method comprises causing each counter to be disabled on a pre-set activity condition being sensed at the node; reading the count recorded at the node for the real time between the enabling and disabling of the counter; reading the real time elapsed during said count; storing the count and time read as traffic data; and re-enabling the counter to continue with the next count.

In at least one embodiment, hardware implementations overcome all the hereinafore-mentioned disadvantages and problems of heretofore-known “software only” solutions.

In at least one embodiment, on disabling a counter, one or more are disabled and the traffic data for each of said counters is stored. Many pre-set activity count conditions can be sensed and used, such as the real time elapsed since enabling the counter, the number of bytes counted since enabling the counter, and the number of data packets counted since enabling the counter.

In at least one embodiment, all the system activity counts are carried out simultaneously at the node by disabling all counters connected to the node once one counter is disabled and enabling all the counters connected to the node when any of the counters connected to the node is enabled.

Alternatively, in at least one embodiment, all the system activity counts are carried out simultaneously over the same time period by disabling all counters on any one of a number of pre-set activity count conditions being sensed at the nodes and enabling all counters simultaneously when any one counter is enabled.

It will be appreciated that in at least one embodiment, the method will also include computing traffic data from the traffic parameters and storing the traffic data for subsequent retrieval. The amount of computation used will depend entirely on the hardware being used.

Further, at least one embodiment of the invention provides a sampling circuit for the measurement and recording of traffic parameters as system activity counts at a node in a data transmission network comprising a plurality of separately operable hardware counters, each for counting a specific system activity count at the node; a time counter having an input signal in the form of a clock operating at fixed interval; operating circuit means for enabling and disabling the operation of each counter; recording circuit means for the individual counts read at the counter for the real time between the enabling and disabling of each counter; and storage circuit means for the individual counts.

In accordance with another feature of at least one embodiment, there is also provided computational circuit means for calculating traffic parameters for the network.

In accordance with an additional feature of at least one embodiment, the operating recording and storage circuit means is carried out by a programmable control circuit.

In accordance with a further feature of at least one embodiment, the counters may be combined into a counter assembly comprising at least one system counter, but more likely, at least two system counters. Ideally, these are a system counter for counting bytes and a system counter for counting packets and always a time counter. It is envisaged that dedicated multiplexors may be used for monitoring and detecting the output of each system counter measured in the number of bits. Such as system counter will be provided by an addressable register in at least one embodiment.

In accordance with at least one embodiment of the invention, there is also provided a sampling circuit comprising: a plurality of addressable registers forming a time counter and at least one system counter; a multiplexor connected to each counter; a global multiplexor connected to each per-counter multiplexor; a control register connected to each multiplexor the control register being programmed to configure each node multiplexor to handle the bits at each counter in accordance with a pre-set count condition and to assert an inhibit and re-set signal for transmission to each counter on sensing the pre-set count condition; the control register being programmed to configure the global multiplexor to combine the outputs of node multiplexors to assert the inhibit and re-set signal; and circuit counting means for the individual system activity counts in real time.

Other features that are considered as characteristic for the invention are set forth in the appended claims.

Although the invention is illustrated and described herein as embodied in system hardware and software, it is, nevertheless, not intended to be limited to the details shown because various modifications and structural changes may be made therein without departing from the spirit of the invention and remain within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram showing the hardware used to carry out at least one embodiment of the invention;

FIG. 2 is a block diagram showing in outline the operation of at least one embodiment of the invention;

FIG. 3 is a flow diagram showing one method according to at least one embodiment of the invention;

FIG. 4 is a block diagram showing a modification to the system of FIG. 1 configured to provide a historical overview of the system activity;

FIG. 5 is a schematic showing how sample windows are provided by the components of FIG. 4; and

FIG. 6 is a block diagram showing a modification to the system of FIG. 4 configured to enable implementation of a network security tool or a network analysis tool.

### DESCRIPTION OF EMBODIMENTS

In the specification the terms “comprise, comprises, comprised and comprising” or any variation thereof and the terms “include, includes, included and including” or any variation thereof are considered to be totally interchangeable and they should all be afforded the widest possible interpretation.

Moreover, reference in the specification to “one embodiment” or “an embodiment” means that a particular feature, structure, or characteristic described in connection with the embodiment is included in at least one embodiment of the invention. The appearances of the phrase “in one embodiment” or “in at least one embodiment” in various places in the specification do not necessarily all refer to the same embodiment, but it may.

Furthermore, the phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional.

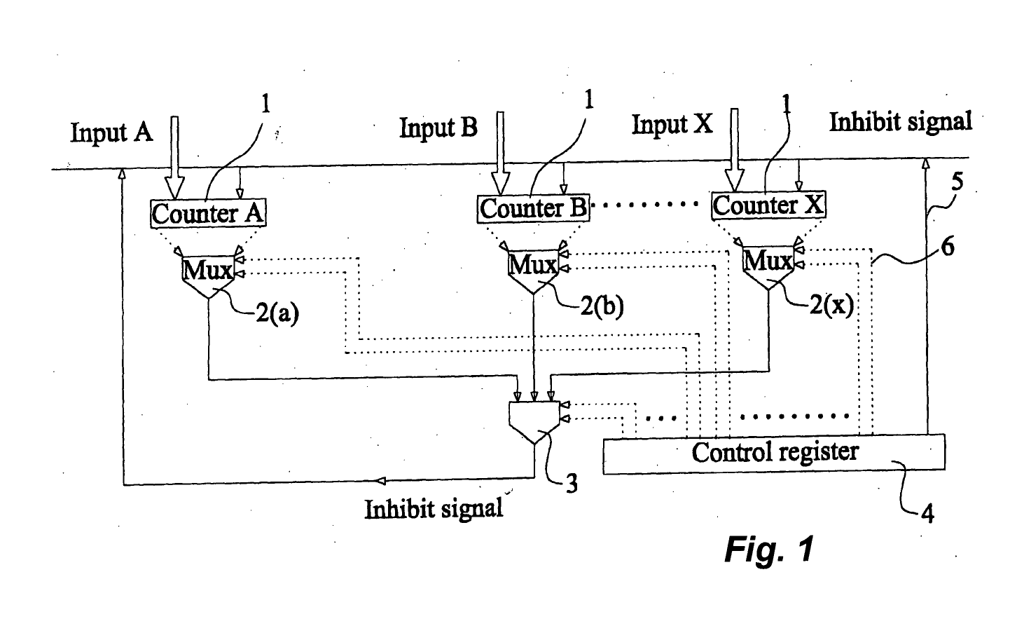

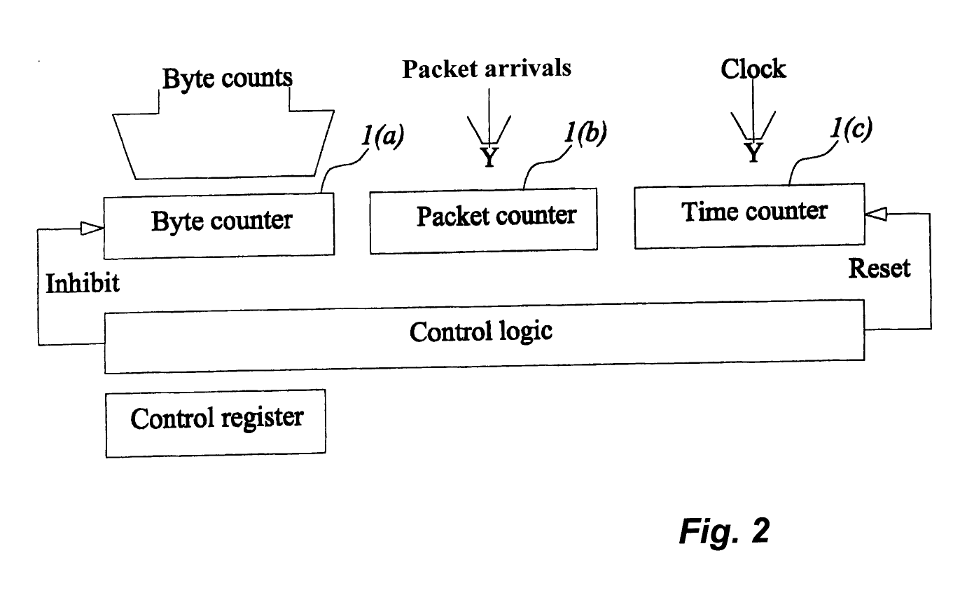

Referring to the drawings, there is provided a plurality of counters labeled in FIG. 1 as Counter A, Counter B and Counter X, each formed by an addressable register 1(a), 1(b) and 1(x), each counter being connected to a multiplexor 2(a), 2(b) and 2(x). All multiplexors 2(a) to 2(x) feed a further selection logic formed by an additional global multiplexor 3. Also provided is a control register 4 which is used for overall control of the unit to configure each of the multiplexors, inhibit signals feeding each of the counters and then reset signals. The inhibit signal is shown by a full line 5 and the other signals by interrupted lines 6. The counters A to X can copy various traffic; for example, referring to FIG. 2, there is shown three counters, the counter 1(a) being a byte counter, counter 1(c) being a clock counter, controlled effectively by a control logic which can send off reset signals and inhibit signals to the various counters. In turn, the control logic will be connected to the control register 4. As the packets arrive, the total byte count is summed in the byte counter, each packet arrival causes the packet counter to be incremented and the time counter is clocked at a fixed frequency. This arrangement allows rate-samples to be made over fixed traffic volumes, whether bytes or packets, as easily as over fixed times; such measurements are vital to implementing efficient traffic management schemes. The control register specifies a single bit which is to be monitored in each of the three counters to set as an activity condition. When the control logic detects that any of these bits has become active, it asserts the inhibit signal causing all counters to be frozen. After the counters have been read by the software, a write to the control register could reset the counters and de-assert the inhibit signal. This arrangement could accurately measure rate samples over a fixed time period by setting the control register so that a bit in the time counter is monitored. To measure rate samples over a fixed number of packets or bytes, the control register could be set so that the number of the byte or packet counters is monitored to form the pre-set activity condition for disabling some or all of the counters.

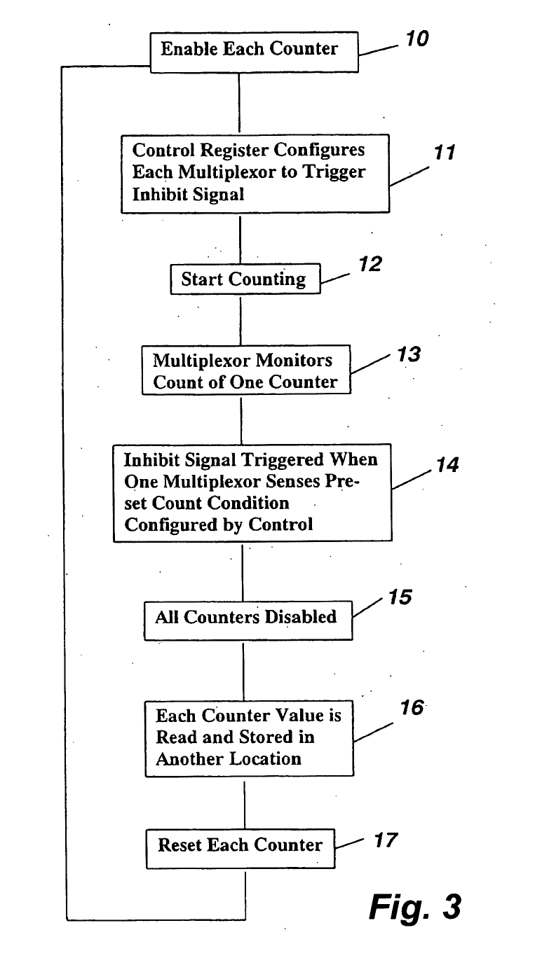

Obviously, the low-order bits of the byte counters would not normally be used. Referring now to FIG. 2 and FIG. 3, in step 10, each counter is enabled and in step 11 the control register configures each multiplexor to trigger an inhibit signal. In step 12, they start counting. The multiplexors 2(a) monitor the count at their respective counters, thus the multiplexor 2(a) monitors the count at the counter 1(a) and so on. When one of the multiplexors senses a preset count condition which has already been configured by the control register, it asserts its output, causing the global multiplexor to deliver the inhibit signal to all counters. Thus, for example, the condition sensed was the real time elapsed, then whichever was the counter carrying out the time functions which could, for example, be the counter 1(x), then the multiplexor 2(x) would assert its output to the global multiplexor in step 14 and then in step 15 the global multiplexor simultaneously disables all counters. In step 16, each counter value is read and stored in another location. In step 17, each counter is reset. One embodiment consists of an arbitrary number of hardware registers coupled by control logic to allow the parallel counting of any number of parameters. Any arbitrary number of characters can be used in the sample and connected to the desired inputs. As mentioned above, one counter could be used to count elapsed time and is clocked at a fixed frequency and another counter could be used to count the number of bytes arriving on a flow on a network element. A central piece of control logic links all the counters and may assert an inhibit signal to a counter or may enable a counter and indeed the logic will normally reset any of the counters setting its value at zero before resetting. Similarly, the logic may monitor any bit of any of the counters. It will also be appreciated that the logic allows operations to be performed simultaneously on any subset of counters. It might allow all the counters to be frozen at a given signal and then allow only some of the frozen counters to be reset.

At least one embodiment allows accurate rate measurements over a specified interval of time. The logic can be arranged so that all the counters are initially frozen, reset and then simultaneously started. For example, a bit in the time counter is monitored and as soon as that bit is set, all counters are simultaneously frozen again. The counters can then be read and their values divided by the elapsed time recorded by the counter to give accurate rate measurements. In this way, an accurate measure of the data rate of a network flow may be obtained.

At least one embodiment of the invention also allows accurate rate measurements over intervals of time defined by the quantity to be measured. For example, it is possible to measure the length of time taken for a specified number of bytes to arrive on a given flow to measure the length of time it takes for 2 n bytes to arrive; simply reset all counters, set them all going simultaneously and then monitor the n'th bit of the byte counter. It will be appreciated that the logic will allow more complicated specifications of timings to be performed. For example, one could measure until a given length of time has passed or until a given number of bytes or packets have arrived on a flow, one could monitor bits in both the time counter and the byte counter, apply a logical OR to them and use the result to trigger a freeze of all counters. At least one embodiment of the invention is a hardware solution to a problem in the present method of measuring and recording various parameters of traffic data at nodes on a data transmission network which methods have heretofore been carried out in software which have led to inherent problems. The count is timed in hardware so that it is exact. Each count is performed on a dedicated piece of hardware, probably silicon based, which reduces existing problems associated with scaling the design up. In at least one embodiment, the hardware includes a small amount of silicon, such as three or more registers and some logic from any applications. The byte count and clock are synchronized hardware giving perfect precision and the hardware arrangement allows fixed volume counts to be performed as easily as fixed time counts.

It will be appreciated that what has been described hereinbefore is a system for providing a sampling of the traffic at a node in a network at a specific time period. While the use of hardware has been emphasized, it will be appreciated that in today's technology applications that the line between hardware and software implementations is often blurred and is not intended to limit the present invention to application using any one set of implementation techniques where the functionality of the invention can be provided by an other type of implementation techniques. For example, in various embodiments of the invention certain or all components can be provided in a software implementation.

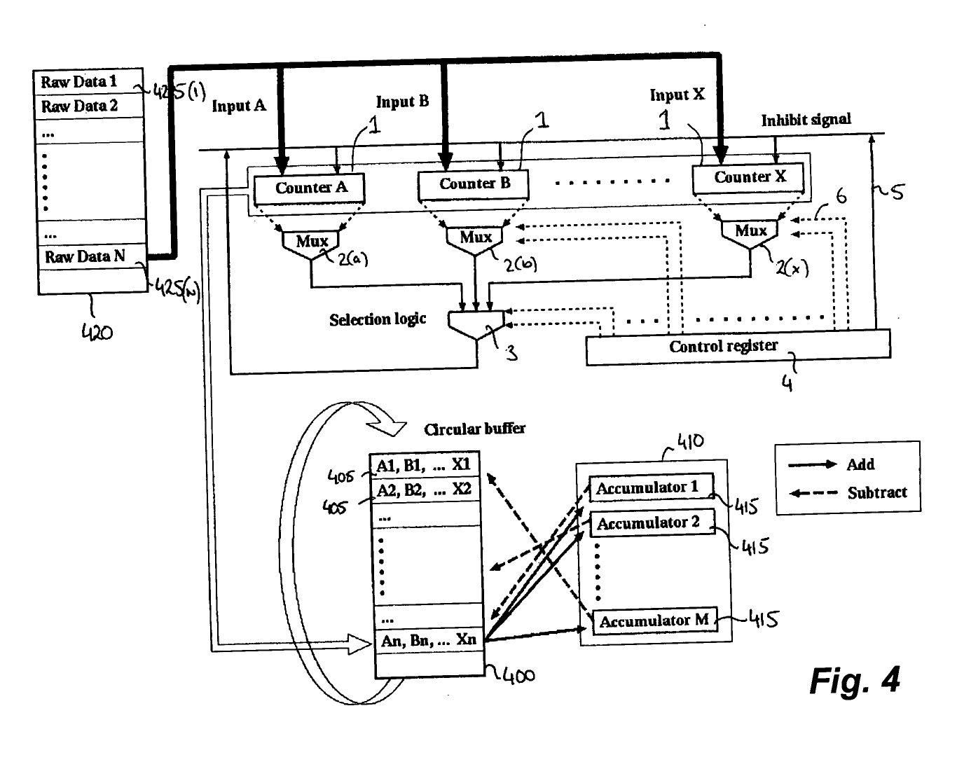

FIG. 4 shows a modification to the system heretofore described which is configured to use the data outputs of one or more of the counters of FIG. 1 or FIG. 2 to provide an historical overview of the system activity over an extended, definable, time period. To achieve this overview, the architecture of FIG. 4 includes a buffer 400, typically a circular buffer of the type known in the art, which includes a plurality of data field 405 each of which are populated from one or more corresponding counters (Counter A, Counter B . . . Counter X). It is possible to time the data storage of each of the fields of the buffer with the corresponding timing signal that is used to clock the counters. With each clocking iteration, a new field is populated within the buffer such that an examination of a plurality of the fields within the buffer can be used to investigate how the system has performed over the time period represented by the number of those fields that are examined. This can be done offline by processing each of the data fields of the buffer in a manner that will be appreciated by those skilled in the art. Alternatively, the present invention can provide, as shown in FIG. 4, an accumulator 410 which also includes a plurality of data fields 415. In accordance with the teachings of the invention, the population of a data field in the buffer causes a corresponding population of one or more data fields in the accumulator. As shown in FIG. 4, a new entry in a buffer data field can be fed to a plurality of data fields in the accumulator where it is summed with the existing entries. In this way, each of the data fields in the accumulator represents an accumulated window representative of the system activity in that period. As the accumulator data fields require the population of at least one of the buffer data fields to provide data for entry, it will be appreciated that the number (M) of data fields in the accumulator 410 is typically at least one less than the number of data fields (N) in the buffer 400. In this way, M=N−1.

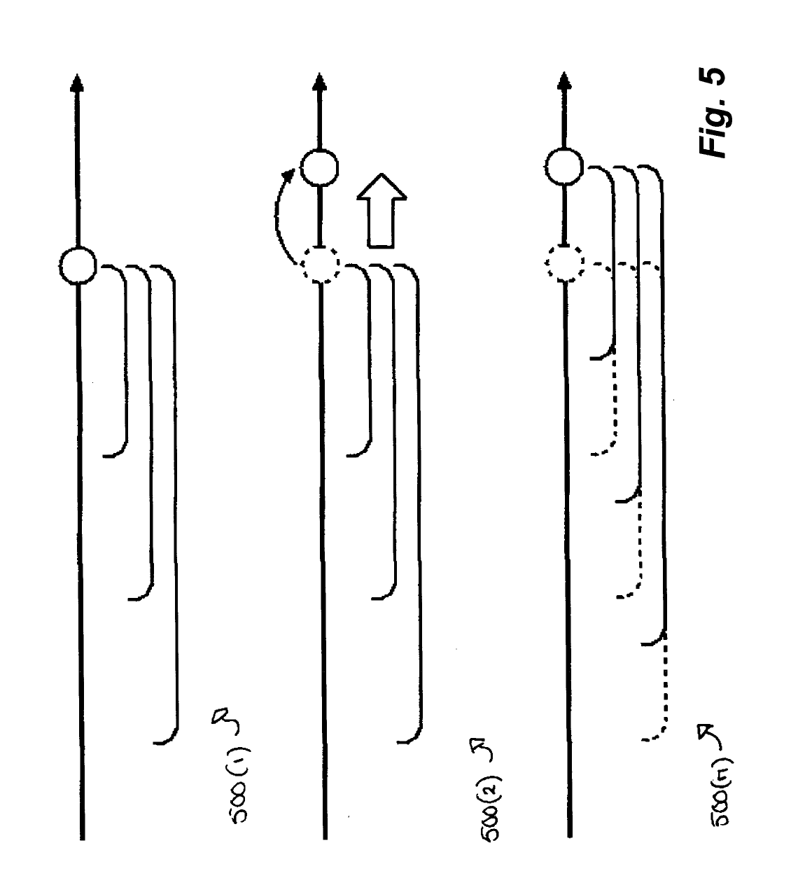

These accumulated windows provide a plurality of sliding windows 500, example of which are shown in FIG. 5 and labeled according to the accumulator that they represent. As will be seen from an examination of FIG. 5, each of the individual windows provides an output indicative of the activity within the time period associated with that window. This can then be used to trace the system activity over time. The windows (or the accumulator data fields which are simply a data representation of the graphic shown in FIG. 5) are created by adding or subtracting entries from each of the buffer data fields 405 to the accumulator window as a new buffer data field is populated from the counters.

The provision of an historical overview of the system activity is advantageous in many ways and has a plurality of applications as will be appreciated by those skilled in the art. For example, by comparing the number of bytes recorded at a particular counter, which indicates the system activity at this specific time period, with the number of bytes in one of the accumulator data fields, it can be ascertained whether the system activity at this instant corresponds with normal expected behavior or whether an anomaly has been experienced. This can then be used to change the characteristics of the network at the node, for example, by increasing or decreasing the available bandwidth at that node, or by changing the type of traffic that is being served and at which priority. Therefore, a system using the sampling circuit of the present invention can be used to monitor and control traffic activity within a network so as to optimize performance based on actual usage. In this way the present invention can be utilized in applications such as a network monitoring tool.

Each of the fields in the buffer, and correspondingly the fields in the accumulator, can be related to the output from one specific counter (e.g., a byte counter) or could be used to provide a representation of the system activity for a plurality of counters (e.g., a byte counter and a packet counter). By providing this population or feeding of the data fields of the buffer from a plurality of different sources, subsequent analysis of these specific data fields can provide information about characteristics of the network above those represented by a single integer. This can be combined with a timing counter so that if each subsequent iteration of the corresponding counter occurred at non-regular timing intervals, that the irregularity of the timing intervals can be normalized to provide a time independent overview of the system activity.

Although not discussed heretofore, it will be understood that the counters of FIG. 4 take raw data from the network traffic as input. The architecture of the present invention may be expanded to provide information on specific system characteristics over an instant and historical time period. By storing this information, the system can also be used to trace and identify which system parameters have contributed to the behavior monitored. As shown in FIG. 4 a second buffer 420, desirably a circular buffer of predetermined length, can be provided and is populated with data that is also used populate the counter. Taking the example of the input to the counter being packet traffic, then the raw data buffer 420 takes each data entry to the counter and stores it in an allocated data field 425 of the buffer. As the population of the raw data buffer 420 is effectively at a higher rate than that of the first buffer 400, it is possible that the raw data buffer may need to be of a greater length than that of the first buffer 400. By storing the raw data that has used to create the stored processed parameter in the counter and as a further processed parameter in the buffer 400 and accumulator 410, it is possible to then subsequently trace exactly what activity has created a specific detected anomaly or other determinable factor. As the data within the raw data will have information related to, for example, the entire contents of a packet (the IP address of the originator of the packet, the port address which was used to access the network, etc.), and this can then be used for security applications within the network, etc. In this way, the sampling circuit of the present invention can be used as a network security tool configured to identify when specific traffic volumes are detected and then to identify which component or user of the network has contributed to this traffic.

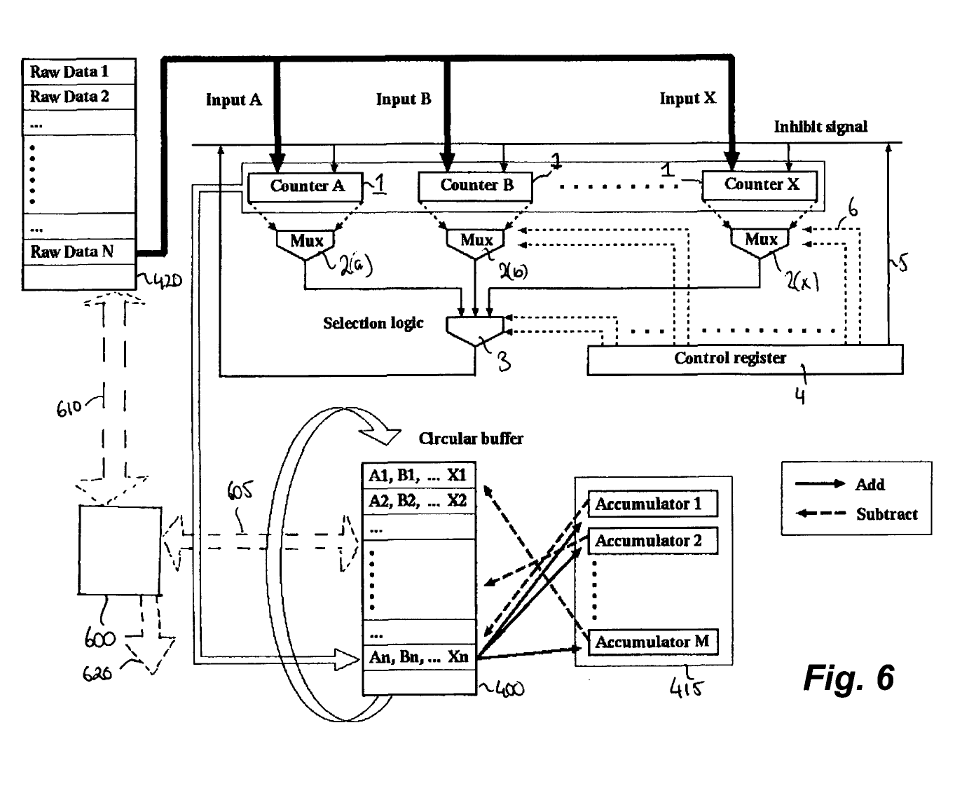

FIG. 6 shows in schematic form an example of the type of modular tool 600 that can be implemented within the context of the present invention so as to provide for network analysis or security applications. In the context of monitoring network usage and providing an output that can be used to change the parameters of the network, the modular tool will typically interface 605 with the first buffer 400 and accumulator 410. In the context of a security tool, the modular tool provides an interrogatory interface between the raw data buffer 420 and the historical overviews provided by the first buffer 400 and accumulator buffer 415. This interrogatory interface or network analysis application provides an output 610 which can be used to prompt other components in the network architecture, which will be well understood by the person skilled in the art, and for the sake of convenience, will not be explicitly shown here.

Although the invention has been described with reference to a hardware implementation, it will be appreciated that the system components of the invention can equally well be implemented using software or indeed a combination of hardware and software. While hardware may be advantageous for certain components such as timing circuitry, etc., it is not intended to limit the present invention in any way except as may be deemed necessary in the light of the appended claims which are intended to define and encompass implementations irrespective of whether they are hardware or software.

The invention is not limited to the embodiments hereinbefore described but may be varied in both construction and detail. Although specific embodiments have been illustrated and described herein, it will be appreciated by those of ordinary skill in the art and others, that a wide variety of alternate and/or equivalent implementations may be substituted for the specific embodiment shown in the described without departing from the scope of the present invention. This application is intended to cover any adaptations or variations of the embodiments discussed herein. Therefore, it is manifested and intended that the invention be limited only by the claims and the equivalence thereof.

What is claimed is:

1. A sampling circuit for the measurement and recording of traffic parameters as system activity counts at a node in a data transmission network comprising:
a plurality of addressable registers forming a time counter and at least one system counter; a multiplexor connected to each counter;
a global multiplexor connected to each per-counter multiplexor;
a control register connected to each multiplexor the control register being programmed to configure each node multiplexor to handle the bits at each counter in accordance with a pre-set count condition and to assert an inhibit and reset-signal for transmission to each counter on sensing the pre-set count condition; the control register being programmed to configure the global multiplexor to combine the outputs of node multiplexors to assert the inhibit and re-set signal;
circuit counting means for the individual system activity counts in circuit counting means for the individual system activity counts in real time; and
a buffer having a plurality of addressable data fields, each of the data fields configured to be populated from at least one counter, sequential data fields of the buffer storing data representative of the individual system activity at sequential periods of time, such that analysis of the plurality of data fields of the buffer provides an historical analysis of the system activity.

2. The sampling circuit as claimed in claim 1, further comprising an accumulator, the accumulator including a second plurality of second addressable data fields, the second data fields being configured to be populated upon addition of new data to the buffer, each of the second addressable data fields in the accumulator providing a data value indicative of system activity over a predefined sample window.

3. The sampling circuit as claimed in claim 1, wherein individual data fields of the buffer may be populated from two or more of the counters, such that analysis of the data fields of the buffer provides an overview of system activity for two or more system parameters.

4. The sampling circuit as claimed in claim 1, wherein the buffer is a circular buffer.

5. The sampling circuit as claimed in claim 1, further comprising another buffer, the other buffer configured to store details of specific system activity at that node.

6. The sampling circuit as claimed in claim 5, further comprising interrogatory means configured to interrogate the other buffer upon determining that a predetermined threshold is met at the buffer, the interrogatory means providing details of the system activity that contributed to the meeting of the predetermined threshold as an output.

7. A sampling circuit as claimed in claim 1, wherein the counters are combined in a counter assembly.

8. A sampling circuit as claimed in claim 7, wherein the counter assembly comprises a combination of a time counter and at least one system counter for counting bytes and for counting packets.

9. A sampling circuit for the measurement and recording of traffic parameters as system activity counts at a node in a data transmission network comprising
a plurality of addressable registers forming a time counter and at least one system counter;
a multiplexor coupled to each counter;
a global multiplexor coupled to each per-counter multiplexor;
a control register coupled to each multiplexor the control register being programmed to configure each node multiplexor to handle the bits at each counter in accordance with a pre-set count condition and to assert an inhibit and reset-signal for transmission to each counter on sensing the pre-set count condition, the control register being programmed to configure the global multiplexor to combine the outputs of node multiplexors to assert the inhibit and re-set signal;
a circuit counter for maintaining the individual system activity counts in real time; and
a buffer having a plurality of addressable data fields, each of the data fields being configured to populate from at least one counter, sequential data fields of the buffer storing data representative of the individual system activity at sequential periods of time, such that analysis of the plurality of data fields of the buffer provides an historical analysis of the system activity.

10. A sampling circuit as claimed in claim 9, further comprising an accumulator, the accumulator including a second plurality of second addressable data fields, the second fields being configured to be populated upon addition of new data to the buffer, each of the second addressable data fields in the accumulator providing a data value indicative of system activity over a predefined sample window.

11. A sampling circuit as claimed in claim 9, wherein the sampling circuit further comprises a counter assembly including a combination of a time counter, a system counter for counting bytes and a system counter for counting packets.

12. A sampling circuit for the measurement and recording of traffic parameters as system activity counts at a node in a data transmission network comprising:
a plurality of addressable registers forming a time counter and at least one system counter;
a plurality of node multiplexors, each node multiplexor coupled to one of the at least one system counter and/or the time counter;
a global multiplexor coupled to the plurality of node multiplexors;
a control register coupled to the global multiplexor and to each of the plurality of node multiplexors, the control register being programmed to configure each node multiplexor to handle the bits at each counter in accordance with a count condition, and configure the global multiplexor to combine the outputs of node multiplexors to assert an inhibit and reset-signal for transmission to each counter upon sensing the count condition;
a circuit counter for counting the individual system activity counts in real time; and
a buffer having a plurality of addressable data fields, each of the data fields being populated from at least one counter, sequential data fields of the buffer storing data representative of the individual system activity at sequential periods of time, such that analysis of the plurality of data fields of the first buffer provides an historical analysis of the system activity.

13. A sampling circuit as claimed in claim 12, wherein the counters are combined in a counter assembly.

14. A sampling circuit as claimed in claim 12, wherein the counter assembly comprises a combination of a time counter, a system counter for counting bytes, and/or a system counter for counting packets.

15. A network security tool configured to identify anomalies in traffic within a network, the tool including:
a sampling circuit for the measurement and recording of traffic parameters as system activity counts at a node in a data transmission network comprising
a plurality of addressable registers forming a time counter and at least one system counter;
a multiplexor coupled to each counter;
a global multiplexor coupled to each per-counter multiplexor;
a control register coupled to each multiplexor the control register being programmed to configure each node multiplexor to handle the bits at each counter in accordance with a pre-set count condition and to assert an inhibit and reset-signal for transmission to each counter on sensing the pre-set count condition, the control register being programmed to configure the global multiplexor to combine the outputs of node multiplexors to assert the inhibit and re-set signal;
a circuit counter for maintaining the individual system activity counts in real time;
a buffer having a plurality of addressable data fields, each of the data fields being configured to be populated from at least one counter, sequential data fields of the buffer storing data representative of the individual system activity at sequential periods of time, such that analysis of the plurality of data fields of the buffer provides an historical trend of the system activity;
an accumulator coupled to the sampling circuit, the accumulator having a second plurality of second addressable data fields, the second fields being configured to be populated upon addition of new data to the buffer, each of the addressable data fields in the accumulator providing a data value indicative of system activity over a predefined sample window; and
interrogatory means coupled to the accumulator, the interrogatory means being configured to identify within the sample windows provided by the accumulator, trends of the system activity and to use these trends to identify anomalous activity within the network, the anomalous activity being defined by system activity which deviates from the historical trend by a predetermined factor.

16. The tool as claimed in claim 15, wherein the tool further comprises a second buffer, the second buffer configured to store the specific network data used to populate the counter such that on identification of anomalous activity, the interrogatory means can ascertain which specific item of network data has contributed to the anomalous activity.

17. A network management tool to manage the traffic within a network, the traffic being processed within the network in accordance with defined network control parameters, the tool comprising:
a sampling circuit for the measurement and recording of traffic parameters as system activity counts at a node in a data transmission network, the sampling circuit having:
a plurality of addressable registers forming a time counter and at least one system counter,
a multiplexor coupled to each counter,
a global multiplexor coupled to each per-counter multiplexor,
a control register coupled to each multiplexor the control register being programmed to configure each node multiplexor to handle the bits at each counter in accordance with a pre-set count condition and to assert an inhibit and reset-signal for transmission to each counter on sensing the pre-set count condition, the control register being programmed to configure the global multiplexor to combine the outputs of node multiplexors to assert the inhibit and re-set signal;
a circuit counter for maintaining the individual system activity counts in real time,
a buffer having a plurality of addressable data fields, each of the data fields being populated from at least one counter, sequential data fields of the buffer storing data representative of the individual system activity at sequential periods of time, such that analysis of the plurality of data fields of the buffer provides an historical trend of the system activity; and
an accumulator coupled to the buffer, the accumulator including a second plurality of second addressable data fields, the second fields being populated on addition of new data to the buffer, each of the second addressable data fields in the accumulator providing a data value indicative of system activity over a predefined sample window, and
interrogatory means coupled to the accumulator and being configured to identify within the sample windows provided by the accumulator trends whether the system activity meets predefined target values and to redefine the network control parameters when the system activity does not meet the predefined target values.

18. The management tool as claimed in claim 17 wherein the predefined target values include at least one quality of service parameter.

19. The management tool as claimed in claim 17 wherein the network control parameter includes available bandwidth.

20. The management tool of claim 17 wherein the interrogatory means are configured to identify the system activity for each class of service being served within the network, and to provide for a modification of how each class of service is being served on ascertaining that a certain class of service does not meet a predefined target value.
